(19) United States
(12) Patent Application Publication
(10) Pub. No.: US 2012/0191344 A1
(43) Pub. Date: Jul. 26, 2012

(54) METHOD AND APPARATUS FOR DISPLAYING LANE COMPLEXITY INFORMATION FOR NAVIGATION SYSTEM

(75) Inventors: Mike Iao, Anaheim, CA (US); Andrew De Silva, Long Beach, CA (US); Mari Hatazawa, Gardena, CA (US)

(73) Assignee: Alpine Electronics, Inc., Torrance, CA (US)

(21) Appl. No.: 13/014,625

(22) Filed: Jan. 26, 2011

(51) Int. Cl. G01C 21/36

(52) U.S. Cl. 701/436; 701/450

(57) ABSTRACT

A display method and apparatus in a navigation system to provide lane complexity information is disclosed. In one embodiment, the navigation system provides guidance information by displaying one or more color indicators on each lane to indicate lane complexity thereon. The lane complexity can be determined by the number of freeways connected at an interchange or how many lane changes the driver has to make before approaching the maneuver point. In another embodiment, each lane on the map is highlighted with the same color as each color indicator which is located on or above the lane. In a further embodiment, a lane and an exit may be highlighted to differentiate from the lane which the vehicle is currently is travelling on to remind the driver of the exit.

### FIELD OF THE INVENTION

This invention relates to a display method and apparatus in a navigation system. More specifically, this invention relates to a navigation-based method and apparatus to provide guidance information to a driver for different lane complexities.

### BACKGROUND OF THE INVENTION

Navigation devices, including portable navigation devices (PNDs), have become more popular and affordable recently for most users. The navigation device can, not only determine the driver's current position by utilizing the Global Positioning System (GPS), but also provide different routing information between the vehicle's current position and the destination, in order to perform abovementioned functions, the navigation device is usually equipped with a sophisticated navigation system comprising navigation computer programs and one or more detailed database to store and provide maps, road networks, geographical features, and waypoint or point-of-interest (POI) information.

More particularly, in a map database, major links such as freeways, highways and streets connecting to major arteries include lane count, lane connectivity, merge and lane expansion, and lane accessibility information. The navigation device is expanding its proximity radius based on the map-matched link as a center point, to traverse all accessible links from the current position and sequence the data of nearest node points. In selecting the appropriate nodes, the navigation device needs to estimate the vehicle directions and prioritize data based on the most probable directions.

A standard automotive navigation system is typically equipped with a routing and guidance feature that provides the user with a turn-by-turn guidance for a route generated between the current vehicle position and the input destination. To generate a route for the driver, the system can traverse the route link list sequentially to decipher the necessary maneuver points. More recently, with the advance of the navigation system, lane guidance emerges to assist the driver on the lane basis for streets with multiple lanes and intersections.

Lane guidance feature with a predetermined route provides the driver turn-by-turn guidance on the lane basis, and the system may recalculate the route if the driver does not stay on the lane suggested by the system. However, the user may need more lane-related information such as when the user should make a lane change (or stay at the current lane) to effectively connect another freeway, or when should make a lane change if an accident happened ahead on the current lane.

U.S. Pat. No. 6,944,538 to Ishibashi et al. discloses a navigation system which eases the burden of changing lanes, taking into consideration the traffic situation surrounding the vehicle. More specifically, the navigation system includes an image capturing device, i.e., a camera, for taking images in an area to the rear of the vehicle, wherein the lane changing information is provided to the driver according to the images taken in vicinity surrounding the vehicle, as shown in FIG. 1. However, Ishibashi does not disclose anything related to providing more lane-related information to help the driver more effectively connect to another freeway or make lane change if an accident happened ahead on the current lane.

U.S. Pat. App. Pub. No. 2009/0222202 discloses a navigation system providing guidance regarding a travel route to a vehicle. More particularly, the navigation system provides more clear guidance when a lane is added to correspond to a road which is taken after a course change, as illustrated in FIG. 2. However, like Ishibashi, it does not disclose anything related to providing more lane-related information to help the driver more effectively connect to another freeway or make lane change if an accident happened ahead on the current lane.

U.S. Pat. App. Pub. No. 2007/0124072 discloses a navigation system providing lane guidance to lead the vehicle to the recommended lane. More specifically, the system receives information regarding the vehicle's current position and moving direction to determine whether the vehicle is moving toward the recommended lane, if the vehicle is moving toward the recommended lane, the system provides lane guidance to the vehicle, as shown in FIG. 3. However, like references mentioned above, it does not teach anything related to providing more lane-related information to help the driver more effectively connect to another freeway or make lane change if an accident happened ahead on the current lane.

Therefore, there remains a need for a new and improved apparatus and method to provide color indicators for each lane to indicate lane complexity, so that the driver can prepare for a lane change if the traffic ahead is congested due to accidents or complex freeway junctions.

### SUMMARY OF THE INVENTION

It is an object of the present invention to provide a guidance display method and apparatus for the driver to easily understand the complexity of the route ahead on lane basis, so the driver can make timely lane change if necessary.

It is another object of the present invention to provide lane guidance information along with freeway shield icons and different color indicators thereon to indicate which lane(s) leads to which freeway ahead.

It is a further object of the present invention to provide a guidance display apparatus and method to define road complexity in terms of freeway interchanges (e.g. if more freeways connect at an interchange, the complexity of the interchange is considered high) and communicate with the driver before approaching the interchange.

It is still a further object of the present invention to provide a guidance display apparatus a method to rate the complexity of the interchange and provide visual or voice guidance to help the driver prepare an upcoming maneuver.

According to one aspect of the present invention, a navigation system comprises one or more database for storing maps and road networks, including lane data and guidance information including a city name or a route number of road; means for providing guidance information on a lane basis including lane complexity information to a vehicle driver; and a display device for displaying each lane of a road and the guidance information, wherein the display device displays a color indication on the guidance information and highlights the lane with a color corresponding to the color indication when the lane matches the route number of road or it is possible to arrive at the city noticed by the guidance information if driving on the lane.

In one embodiment, the lane complexity is determined by the number of freeways connected at an interchange. In another embodiment, the lane complexity may be determined by how many lane changes the driver has to make before approaching the maneuver point. In a further embodiment, the lane complexity may be determined by traffic conditions ahead.

In another aspect, the present invention provides a guidance display method comprising the steps of: detecting a vehicle's current position; storing maps and road networks, including lane data; providing guidance information to the vehicle driver; and displaying the current position of the vehicle and the guidance information, wherein the guidance information provides one or more color indicators on each lane to indicate lane complexity thereon.

In one embodiment, step of providing guidance information comprises the step of providing guidance information on a lane basis. In another embodiment, the step of providing guidance information comprises the step of placing one or more freeway shield icons on each lane to lead a driver to a desired freeway. In a further embodiment, the step of providing guidance information comprises the step of highlighting a lane and an exit to show the driver said lane leads to said exit.

The present invention together with the above and other advantages may best be understood from the following detailed description of the embodiments of the invention illustrated in the drawings below.

### BRIEF DESCRIPTION OF THE DRAWINGS

FIG. 1 illustrates a prior art, related to a navigation system which eases the burden of changing lanes, taking into consideration the traffic situation surrounding the vehicle.

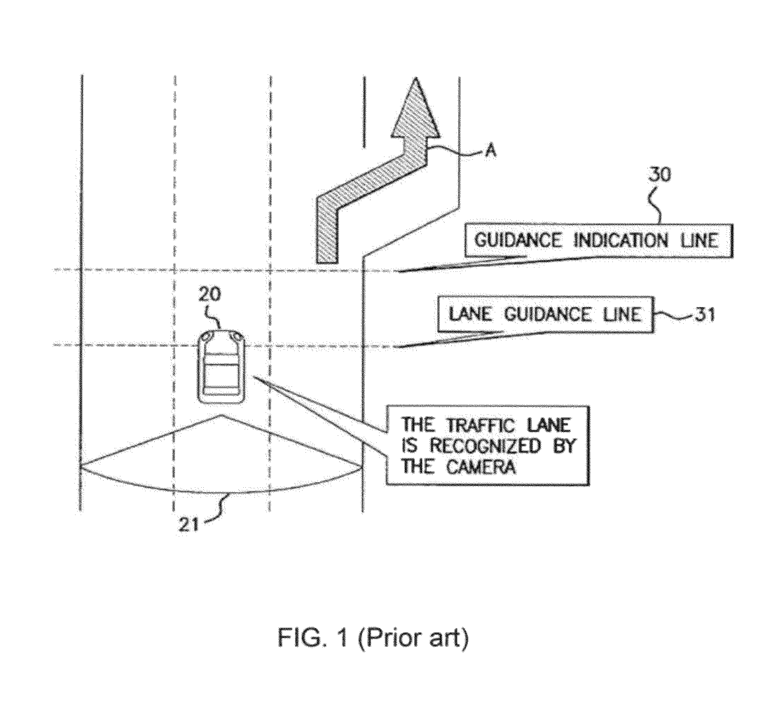

FIG. 2 illustrates a prior art, related, to a navigation system providing more clear guidance when a lane is added to correspond to a road which is taken after a course change.

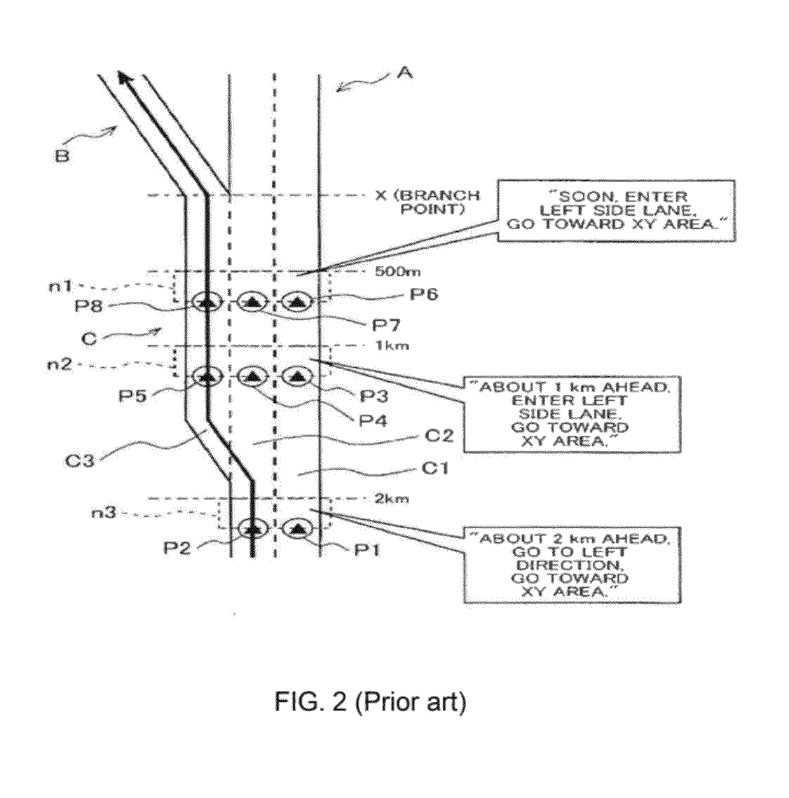

FIG. 3 illustrates a prior art, related to a navigation system providing guidance information to the vehicle when the vehicle is moving toward the direction of the recommended lane.

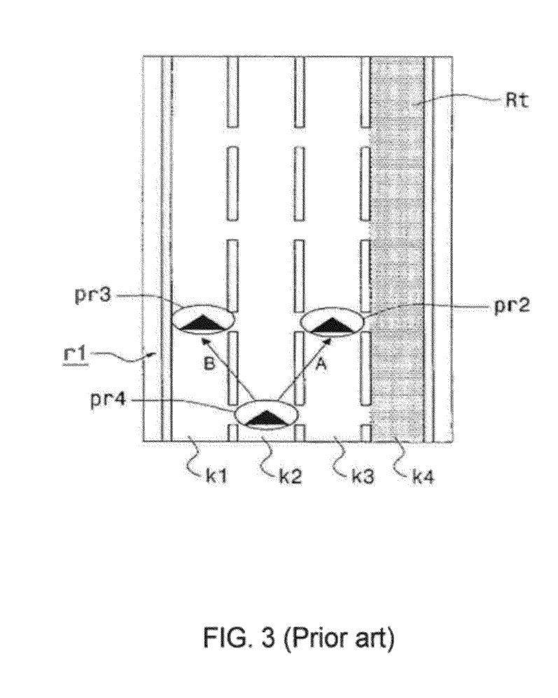

FIG. 4 illustrates a functional block diagram showing an example of structure of a navigation system implementing the method and apparatus to provide lane complexity guidance information to a driver.

FIGS. 5a and 5b depict one embodiment of the present invention wherein a number of lane complexity indicators are shown on each lane and shield icons thereabove.

FIGS. 6a and 6b illustrate another embodiment of the present invention wherein the freeway shield icons are placed on each lane to lead the driver to a desired freeway

FIGS. 7a and 7b illustrate a further embodiment of the present invention wherein if one freeway is going to become one lane, an original route can be deviated from the vehicle current lane to a new lane, which the driver can keep travelling on even the freeway becomes one lane.

FIG. 8 illustrates a further embodiment of the present invention wherein a lane leading to an exit is highlighted to differentiate from a lane on which a vehicle is travelling.

FIG. 9 illustrates another aspect of the present invention, depicting a guidance display method for displaying the vehicle's current position on a lane basis and one or more color indicators to indicate lane complexity thereon.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

This invention relates to a display method and apparatus in a navigation system. More specifically, this invention relates to a navigation-based method and apparatus to indicate lane complexity and provide such information to the driver. As stated above, although lane guidance with predetermined route is a useful feature in the navigation system to assist the driver on the lane basis for streets with multiple lanes and intersections, the system may not provide lane complexity information to prepare the driver for an upcoming freeway interchange and the driver can make timely lane change if necessary.

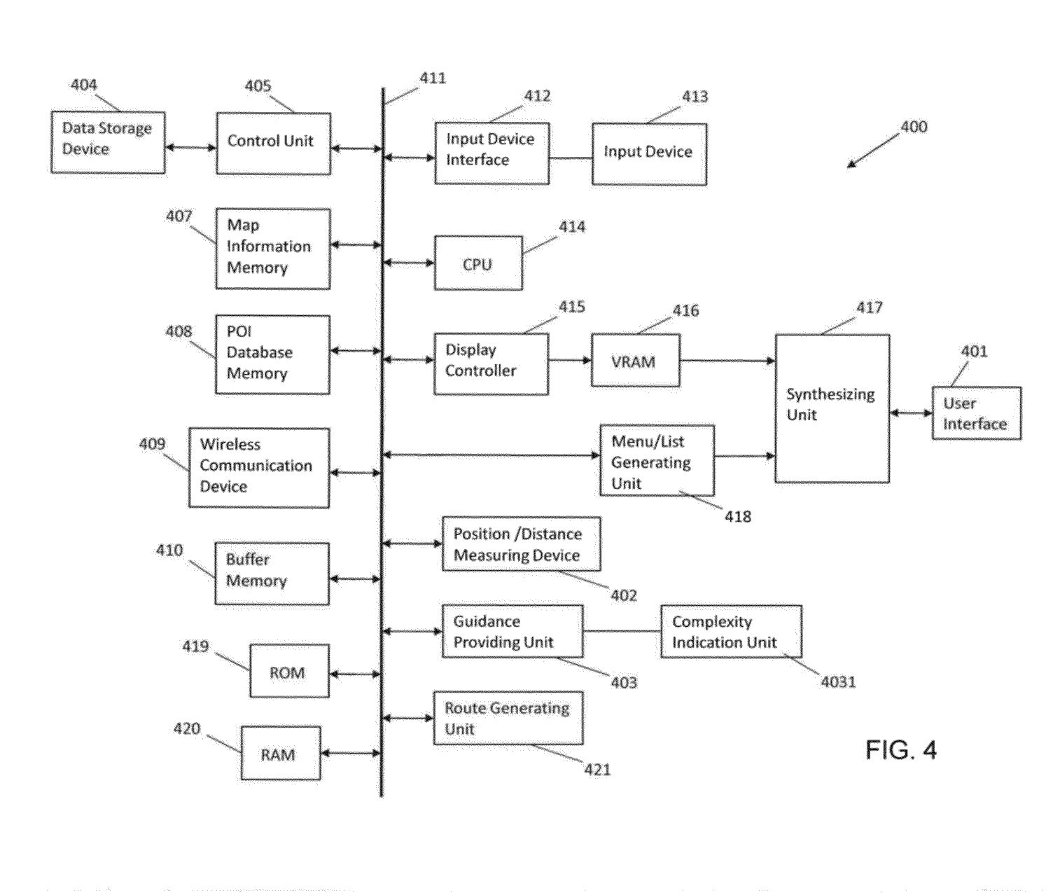

FIG. 4 is a block diagram showing an example of structure of a navigation system 400 for implementing the present invention. The navigation system 400 includes a user interface 401; a data storage device 404 such as a hard disc, CD-ROM, DVD or other storage means for storing the map data; and a control unit 405 for controlling an operation for reading the information from the data storage device 404. In one embodiment, the user interface 401 is a display unit which is configured to display maps, POIs and guidance information. In some embodiments, the navigation system 400 may be portable.

The navigation system 400 also includes a position and distance measuring device 402 for measuring the present vehicle position or user position. For example, the position and distance measuring device 402 has a speed sensor for detecting a moving distance, a gyroscope for detecting a moving direction, a microprocessor for calculating a position, a GPS (global positioning system) sensor detecting the vehicle's current position by receiving radio waves generated by a satellite. In one embodiment, the GPS sensor is, for example, used as the current position detection portion, but the speed sensor, a steering sensor, an altimeter or the like can be used individually or in combination instead of the GPS sensor.

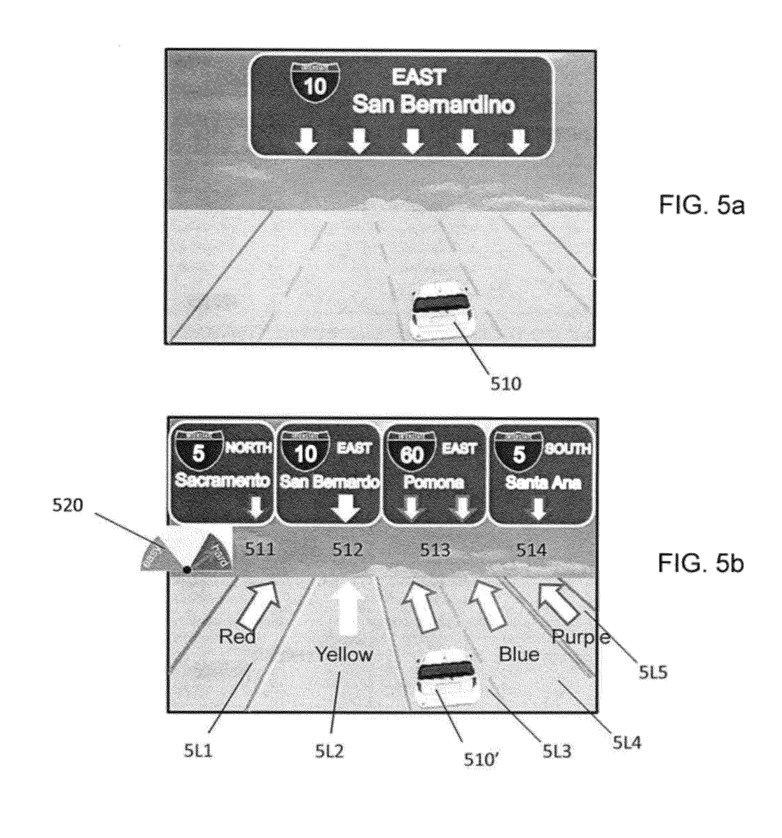

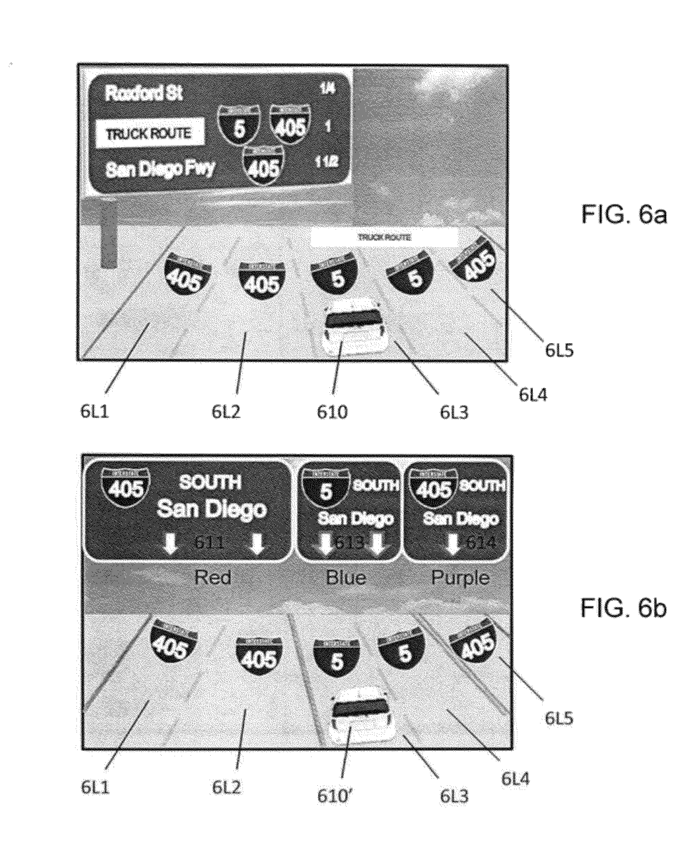

As shown in FIG. 4, the navigation system 400 may also include a guidance providing unit 403 to provide guidance information to the driver on a lane basis; a map information memory 407 for storing the map information which is read from data storage 404; a route generating unit 421 adapted to retrieve the map and road network data from the database and generate a calculated route; and a database memory 408 for storing database information such a point of interest (POI) information which is read out from the data storage device 404, in an exemplary embodiment in the present invention, the guidance providing unit 403 is communicatively coupled with the map information memory 407, the route generating unit 421 and the vehicle position detecting unit 402 to match the vehicle's current position with the lane data and display such information on the user interface 401. More specifically, if the guidance information is provided to the driver, the system 400 may instruct the route generating unit 421 not to provide a calculated route avoid unnecessary route recalculation illustrated above. In an exemplary embodiment, the guidance providing unit 403 may include a complexity indication unit 4031 to show complexity of each lane according to the traffic condition ahead from the vehicle's current position. One or more color indicators as shown in FIGS. 5b and 6 may be used to show complexity of the lanes, for example, red may indicate a complex freeway junction or congested traffic ahead while blue may indicate no complex freeway junction or light traffic ahead.

The block diagram of FIG. 4 further includes an input device 413 for executing a menu selection operation, an enlarge/reduce operation, a destination input operation, etc. and an input device interface 412. In one embodiment, the input device 413 is a remote controller. The navigation system 400 also includes a bus 411 for interfacing the above units in the system, a processor (CPU) 414 for controlling an overall operation of the navigation system 400, a ROM 419 for storing various control programs such as a route search program and a map matching program necessary for navigation control, a RAM 420 for storing a processing result such as a guide route, a display controller 415 for generating map image (a map guide image and an arrow guide image) on the basis of the map information, a VRAM 416 for storing images generated by the display controller 415, a menu/list generating unit 418 for generating menu image/various list images, a synthesizing unit 417, a wireless communication device 409 to retrieve data from a remote server, the Internet or other communication networks, and a buffer memory 410 for temporary storing data for ease of data processing.

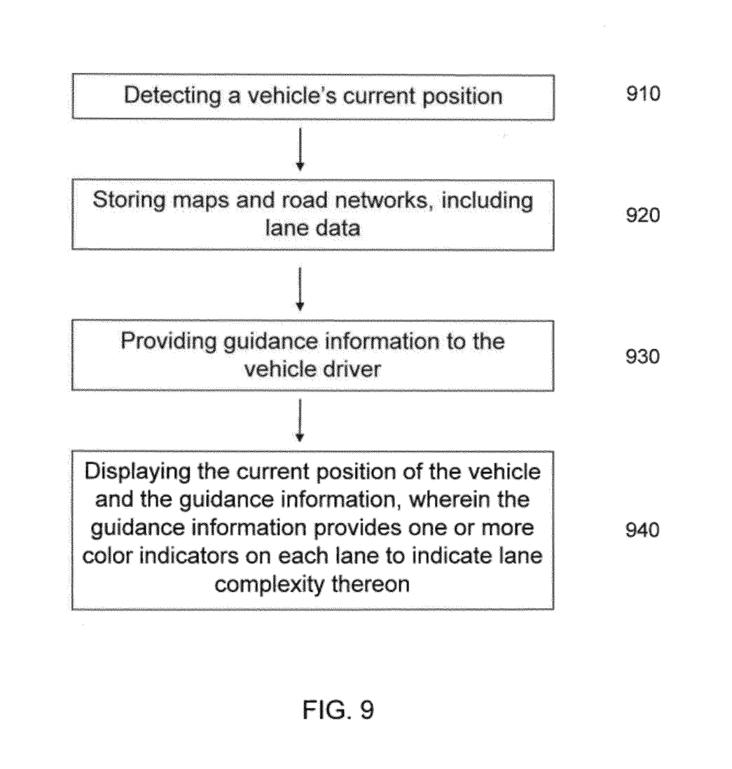

A program for conducting the operation of providing guidance information as to lane complexity in the present invention shown in the flow charts of FIG. 9 is stored in the ROM 419 or other memory and is executed by the CPU 414. The CPU 414 controls an overall operation of the guidance display method and apparatus in the present invention.

Referring to FIG. 5a, a vehicle 510 is travelling on a freeway without route guidance. The driver may not have any information about the traffic condition ahead. If an accident happens on the lane the vehicle is currently travelling on, the driver may experience traffic congestion before he can make a lane change. The driver may experience traffic congestion as well if there is a complex highway interchange ahead.

In an exemplary embodiment shown in FIG. 5b, a current position of a vehicle 510′ is at lane 5L3 of the freeway without route guidance, which has five lanes 5L1 to 5L5. A number of complexity indicators 511 (red), 512 (yellow), 513 (blue) and 514 (purple) may be shown on each lane and corresponding shields above. For example, the red indicator 511 may indicate heavy traffic congestion or a complex freeway interchange ahead while the blue indicator may indicate light traffic or less complex freeway interchange ahead. The wireless communication device 409 is adapted to receive traffic information from remote servers or other communication networks and communicated with the position measuring device 402 and the complexity indication unit 4031 to provide indication of lane complexity. The freeway interchange information may be stored in the map information memory 407 communicated with the position measuring device 402 and the complexity indication unit 4031 to provide freeway interchange information. With the assistance of the color indicators, the driver can make an early lane change to avoid traffic caused by accident or complex freeway interchange. A complexity meter 520 can also be used to indicate lane complexity. Both embodiments in FIGS. 5a and 5b can also be applied to situations with route guidance.

in another embodiment, the freeway shield icons can be placed on each lane to lead the driver to a desired freeway. As shown in FIG. 6a, a vehicle 610 is traveling on lane 6L3 which would lead the driver to the Freeway 5 if the driver keeps traveling on lane 613. This feature can help the driver decide which lane he/she wants to stay to the desired freeway and avoid last minute lane change which may sometimes cause accidents.

In addition to providing freeway shield icon on each lane, the lane complexity indicators can also be provided to the driver as illustrated in FIG. 6b. As stated above, the color may indicate lane complexity ahead. For example, red arrows 611 means the traffic is congested ahead due to accidents or complex freeway interchanges, while blue arrows 613 means the traffic is light and there may be no complex freeway interchanges. With the lane complexity information, the driver can decide whether to stay on the current lane or switch to other lanes with less traffic.

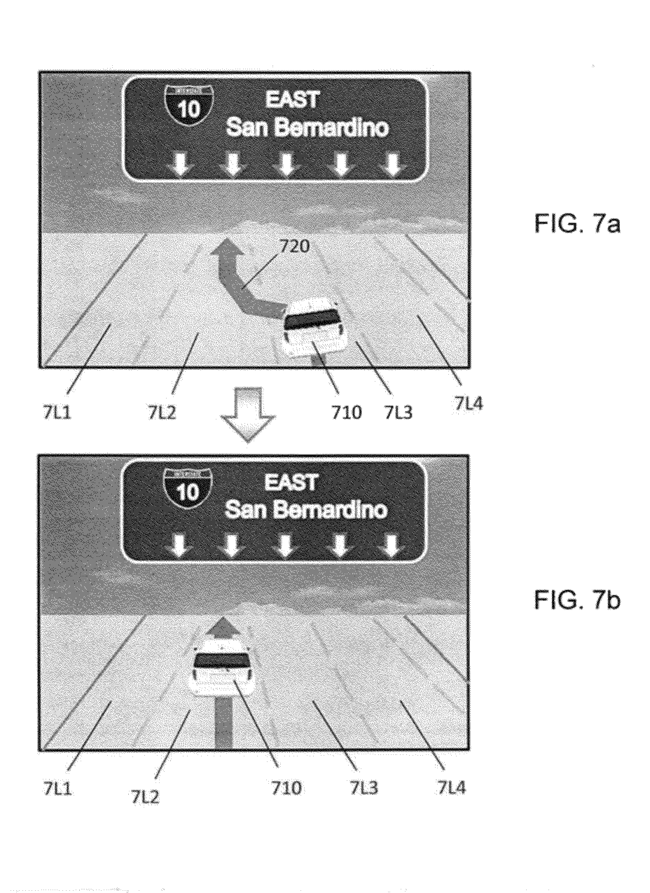

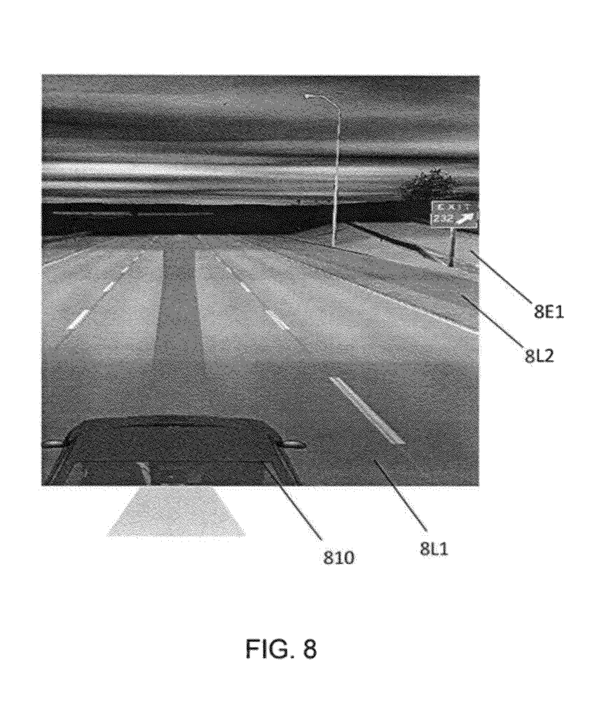

FIGS. 7a and 7b illustrate a situation with route guidance and if the Freeway 10 is going to become one lane, an original route 720 can be deviated from a vehicle 710's current lane 7L3 to a new lane 7L2, which the driver can keep travelling on even the Freeway 10 becomes one lane. This information can help the driver avoid last minute lane change which may sometimes cause accidents. In a further embodiment shown in FIG. 8, the system in the present invention can highlight a lane leading to an exit differently from a lane on which a vehicle is travelling. For example, a vehicle 810 is traveling on lane 8L1 which is highlighted with blue color, while lane 8L2 leading to an exit 8E1 is highlighted with red color so that if the driver wants to exit the freeway, he/she can switch to the lane highlighted with red color in advance without lane minute lane change.

According to another aspect illustrated in FIG. 9, a guidance display method comprises the steps of: detecting a vehicle's current position 910; storing maps and road networks, including lane data 920; providing guidance information to the vehicle driver 930; and displaying the current position of the vehicle and the guidance information 940, wherein the guidance information provides one or more color indicators on each lane to indicate lane complexity thereon.

In one embodiment, step of providing guidance information 930 comprises the step of providing guidance information on a lane basis. In another embodiment, the step of providing guidance information 930 comprises the step of placing one or more freeway shield icons on each lane to lead a driver to a desired freeway. In a further embodiment, the step of providing guidance information 930 comprises the step of highlighting a lane and an exit to show the driver said lane leads to said exit.

Having described the invention by the description and illustrations above, it should be understood that these are exemplary of the invention and are not to be considered as limiting. Accordingly, the invention is not to be considered as limited by the foregoing description, but includes any equivalents.

1. A navigation system comprises:
one or more database for storing maps and road networks, including lane data and guidance information including a city name or a route number of road;
means for providing guidance information on a lane basis including lane complexity information to a vehicle driver; and
a display device for displaying each lane of a road and the guidance information,
wherein the display device displays a color indication on the guidance information and highlights the lane with a color corresponding to the color indication when the lane matches the route number of road or it is possible to arrive at the city noticed by the guidance information if driving on the lane.

2. The navigation system of claim 1, wherein the means for providing guidance information including lane complexity information includes means for placing one or more freeway shield icons on each lane to lead a driver to a desired freeway.

3. The navigation system of claim 1, wherein the lane complexity is determined by degree of traffic congestion and number of freeway interchange.

4. The navigation system of claim 2, wherein one or more color indicators to indicate lane complexity are displayed along with the freeway shield icons on each lane.

5. The navigation system of claim 1, wherein the means for providing guidance information including lane complexity information further comprises means for highlighting a lane and an exit to show the driver said lane leads to said exit.

6. A guidance display method, comprising:
detecting a vehicle's current position;
storing maps and road networks, including lane data;
providing guidance information to the vehicle driver on a lane basis; and
displaying the current position of the vehicle and the guidance information,
wherein the guidance information provides one or more color indicators on each lane to indicate lane complexity thereon.

7. The guidance display method of claim 6, wherein each lane is highlighted with the same color as each color indicator which is located on or above each lane.

8. The guidance display method of claim 6, wherein the step of providing guidance information includes the step of placing one or more freeway shield icons on each lane to lead a driver to a desired freeway.

9. The guidance display method of claim 6, wherein the lane complexity is determined by degree of traffic congestion and number of freeway interchange.

10. The guidance display method of claim 8, wherein one or more color indicators to indicate lane complexity are displayed along with the freeway shield icons on each lane.

11. The guidance display method of claim 6, wherein the step of providing guidance information on lane basis further comprises the step of highlighting a lane and an exit to show the driver said lane leads to said exit.

12. A display apparatus for a navigation system comprising:
a user interface;
a vehicle position detecting unit to detect a vehicle's current position;
at least one database to store and provide maps and road networks, including lane data; and
a guidance providing unit to provide guidance information to a driver on a lane basis,
wherein the guidance providing unit is communicatively coupled with the database and the vehicle position detecting unit to match the vehicle's current position with the lane data, and provides guidance information by displaying one or more color indicators on each lane to indicate lane complexity thereon.

13. The display apparatus of claim 12, wherein each lane is highlighted with the same color as each color indicator which is located on or above each lane.

14. The display apparatus of claim 12, wherein the guidance providing unit is adapted to display one or more freeway shield icons on each lane to lead a driver to a desired freeway.

15. The display apparatus of claim 12, wherein the lane complexity is determined by degree of traffic congestion and number of freeway interchange.

16. The display apparatus of claim 14, wherein one or more color indicators to indicate lane complexity are displayed along with the freeway shield icons on each lane.

17. The display apparatus of claim 12, wherein the guidance providing unit is adapted to highlight a lane and an exit to show the driver said lane leads to said exit.
